(19) United States
(12) Patent Application Publication
(10) Pub. No.: US 2005/0132971 A1
(43) Pub. Date: Jun. 23, 2005

(54) Aquarium

(75) Inventor: Paul W Sulski, Johannesburg (ZA)

Correspondence Address: AKERMAN SENTERFITT, P.O. BOX 3188, WEST PALM BEACH, FL, 33402-3188, US

(73) Assignee: Square Forest South Africa (Propietary) Limited, Johannesburg (ZA)

(21) Appl. No.: 10/502,136

(22) PCT Filed: Aug. 15, 2003
(86) PCT No.: PCT/ZA03/00114

(30) Foreign Application Priority Data
Aug. 16, 2002 (ZA) 02/6578

(51) Int. Cl. A01G 9/02

(52) U.S. Cl. 119/246

(57) ABSTRACT

The invention concerns an at least partially transparent container for use as an aquarium, herbarium, terrarium, vivarium or the like. The container is characterized therein that it constitutes a building unit that is adapted for engaging complimentarily shaped containers so as to form a display arrangement. The container includes a substantially continuous interior surface defining a chamber for housing fish and/or plants and/or animal or insect matter and/or decorative or ornamental matter; radiused corner zones between interior surfaces of neighboring walls of the container, and at least one sealable aperture extending through a wall of the container for permitting access to the fish and/or plants and/or animal or insect matter and/or decorative or ornamental matter within the container. The invention extends to an aquarium, herbarium, terrarium or vivarium arranged within a transparent and hollow glass brick, as well as to a method of manufacturing a terrarium.

### TECHNICAL FIELD

The invention relates to a container. More particularly, the invention relates to a container for use as a housing for an aquarium, herbarium, terrarium, vivarium or the like. The invention also extends to a terrarium arranged within the container and to a method of producing such a terrarium. The invention further extends to furniture incorporating one or more of such containers therein.

### BACKGROUND ART

There are various aquariums, herbariums, terrariums and vivariums known and available in the market place. One of the disadvantages of known systems and ecosystems of this nature is the presence of unwanted bacteria and moulds within the housing and the lack of effective control of contaminants, such as spores, bacteria, fungi, plant rust and insects in the production environment, raw and production materials, and finished product.

Another disadvantage is the lack of physical cooperativeness between different such systems and the relatively limited variations that are available.

### OBJECT OF THE INVENTION

It is one object of the invention to provide a container for use as a housing for an aquarium, herbarium, terrarium, vivarium or the like that will overcome or at least minimize some of the disadvantages associated with known containers of this kind.

It is a further object of the invention to provide a terrarium arranged within the container, as well as a method of producing such a terrarium.

It is yet a further object of the invention to provide furniture incorporating the container.

### DISCLOSURE OF THE INVENTION

According to the invention there is provided an at least partially transparent container for use as an aquarium, herbarium, terrarium, vivarium or the like, the container being characterized therein that it constitutes a building unit which is adapted for engaging complimentarily shaped containers so as to form a display arrangement; the container further being characterised therein that it includes a substantially continuous interior surface defining a chamber for housing fish and/or plants and/or animal or insect matter and/or decorative or ornamental matter; radiused corner zones between interior surfaces of neighboring walls of the container; and at least one sealable aperture extending through a wall of the container for permitting access to the fish and/or plants and/or animal or insect matter and/or decorative or ornamental matter within the container.

The applicant believes that by providing radiused corner zones, which in effect define a substantially continuous interior surface within the container, it limits growth potential of contaminants, which often nest in crevices and joints within a container.

The container may be a substantally square or rectangular container comprising two substantially parallel sidewalls, two opposing substantially parallel end walls, and two parallel walls defining a floor and roof wall respectively of the container. In one form of the invention, the container may be a hollow, transparent glass brick dimensioned to engage similar glass bricks so as to form a display arrangement, such as a glass wall.

The container may include a tight-fitting plug for sealing the aperture, which may typically extend through the roof of the container. The plug may be manufactured from any one of cork, wood, rubber or glass.

According to another aspect of the invention there is provided an aquarium, herbarium, terrarium or vivarium comprising fish and/or plants and/or animal or insect matter and/or decorative or ornamental matter, the aquarium, herbarium, terrarium or vivarium being characterized therein that it is arranged within a hollow at least partially transparent container which is characterised therein that it includes a substantially continuous interior surface and radiused corner zones between interior surfaces of neighboring walls of the container; and at least one aperture extending through a wall of the container for permitting access to the animal and/or plant and/or insect matter and/or fish and/or decorative, ornamental or the like matter within the container.

According to another aspect of the invention there is provided a temporarily self-sustaining terrarium characterized therein that it is arranged within a hollow glass brick which includes a substantially continuous interior surface and radiused corner zones between interior surfaces of neighboring walls of the brick; and at least one aperture extending through a wall of the glass brick for permitting access to contents within the brick; the terrarium further being characterised therein that it includes a first drainage layer comprising a mixture of approximately 50% charcoal and 50% river sand.

The terrarium may include a second layer for supporting plant material therein, the second layer comprising either a mixture of approximately 55% potting soil and 45% river sand for desert-type plants, or a mixture of approximately 80% potting soil and 20% peetmoss for forest-type plants.

According to another aspect of the invention there is provided a method of producing a temporarily self-sustaining terrarium that it is arranged within an at least partially transparent container, the method comprising the steps of introducing a first drainage soil layer comprising a mixture of approximately 50% charcoal and 50% river sand into the container and leveling the drainage layer; introducing a second soil layer comprising either a mixture of approximately 55% potting soil and 45% river sand for desert-type plants, or a mixture of approximately 80% potting soil and 20% peetmoss for forest-type plants into the container and leveling the soil layer; sterilizing the soil mixtures by subjecting the container to microwave treatment so as to remove potentially unwanted bacteria; sealing the container and allowing the same to cool for at least 4 hours; introducing plant material into the container and sealing the container so as to create an ecosystem within which the plant material can grow in the absence of added oxygen or water.

According to a further aspect of the invention there is provided a display arrangement comprising a series of containers, wherein each container includes fish and/or plants and/or animal or insect matter and/or decorative or ornamental matter, and wherein each container includes a substantially continuous interior surface and radiused corner zones between interior surfaces of neighboring walls of the container; and at least one aperture extending through a wall of the container for permitting access to contents within the container.

The containers may be stacked upon one another or may otherwise be connected to one another.

According to yet a further aspect of the invention there is provided a wall structure comprising a series of containers, wherein each container includes fish and/or plants and/or animal or insect matter and/or decorative or ornamental matter, and wherein each container includes a substantially continuous interior surface and radiused corner zones between interior surfaces of neighboring walls of the container; and at least one aperture extending through a wall of the container for permitting access to contents within the container.

More particularly, the wall structure may be a glass wall comprising a series of hollow glass bricks wherein each brick includes fish and/or plants and/or animal or insect matter and/or decorative or ornamental matter.

According to yet another aspect of the invention there is provided furniture incorporating therein one or more of an aquarium, herbarium, terrarium or vivarium comprising fish and/or plants and/or animal or insect matter and/or decorative or ornamental matter wherein the aquarium, herbarium, terrarium or vivarium is arranged within a hollow glass brick.

### SPECIFIC EMBODIMENT OF THE INVENTION

Without limiting the scope thereof, a few embodiments of the invention will now be described by way of example only and with reference to the accompanying drawings wherein—

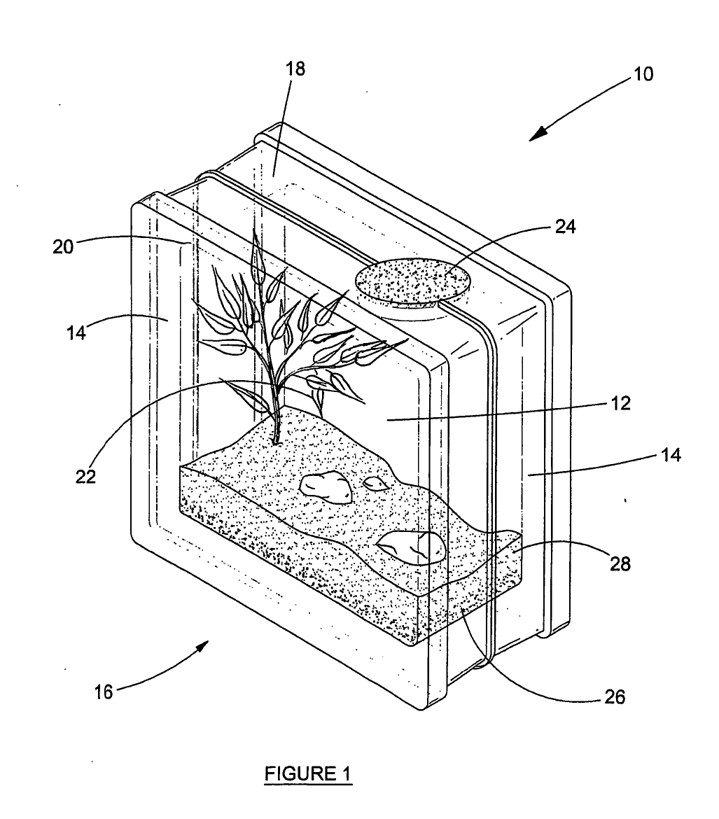

FIG. 1 is a perspective view of a container according to the invention where the container is used as a housing for a terrarium;

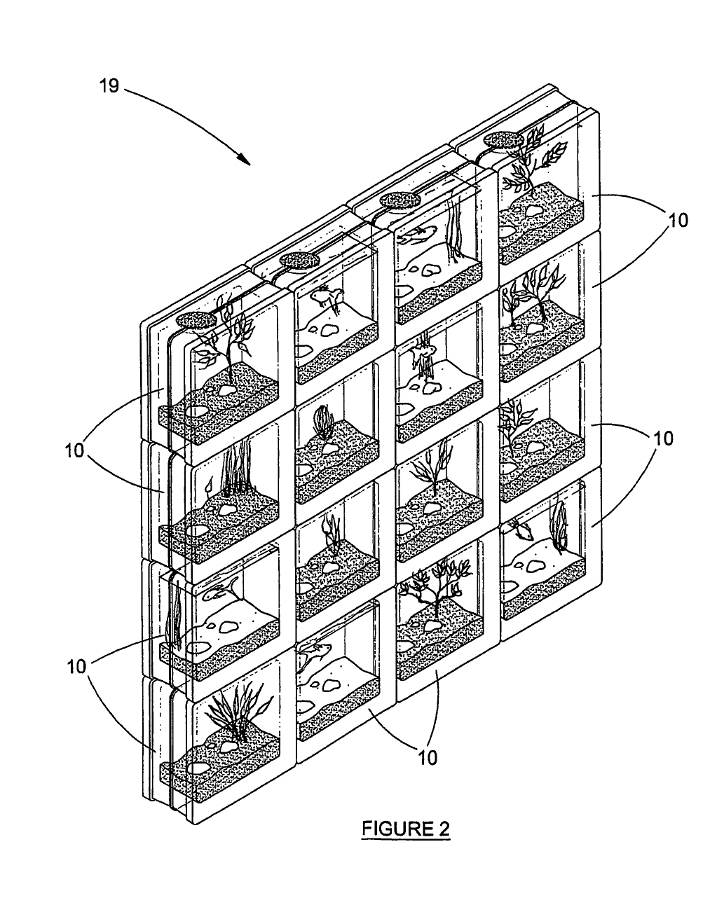

FIG. 2 is a perspective view of a glass wall comprising of a series of containers according to FIG. 1;

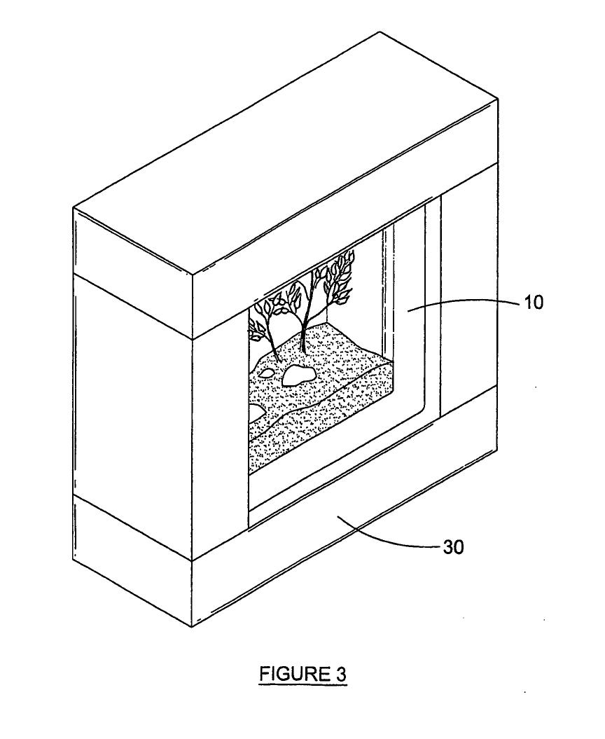

FIG. 3 is a container according to FIG. 1, encased within a frame for displaying the container in use;

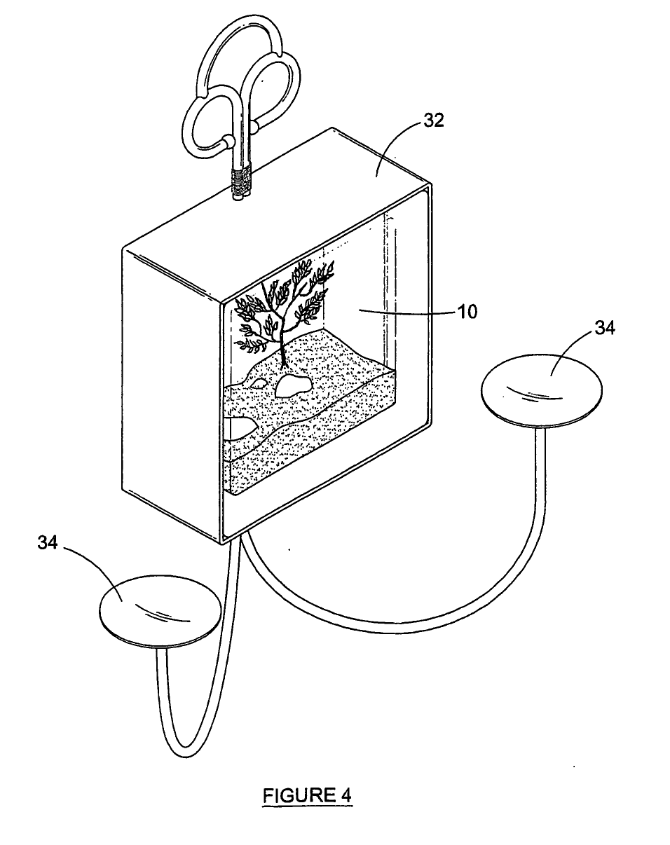

FIG. 4 is an ornamental arrangement adapted to be mounted on a wall or the like planar surface and including a container according to the invention; and

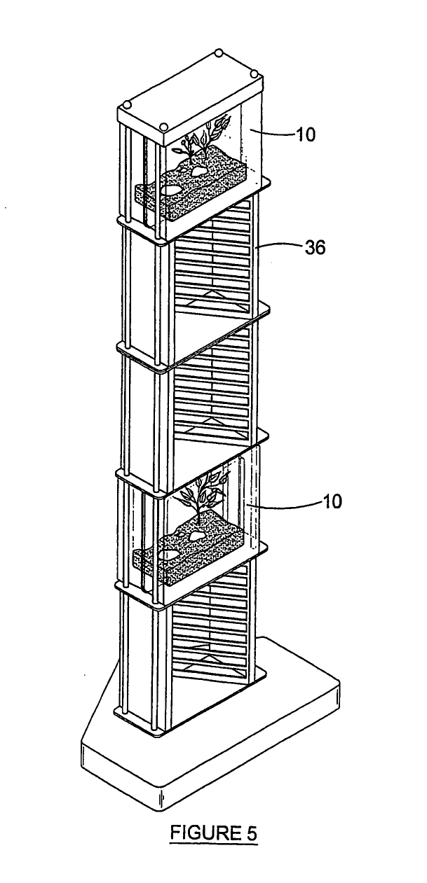

FIG. 5 is a perspective view of a CD stand incorporating two containers according to the invention.

A container according to the invention is generally designated by reference numeral 10. The container 10, which is used as an aquarium, herbarium, terrarium, vivarium or the like, is characterized therein that it constitutes a building unit which is suitably dimensioned for engaging complimentarily shaped containers 10 to form a display arrangement.

The container 10 comprises at least two substantially parallel walls. Particularly, the container 10 is a substantially square or rectangular container 10 comprising two substantially parallel sidewalls 12, two opposing substantially parallel end walls 14, and two parallel walls defining a floor 16 and roof wall 18 respectively of the container 10.

The container 10 includes a substantially continuous interior wall surface. Particularly, the container 10 includes radiused corner zones 20 defined between the walls of the container 10, and more particularly between neighboring interior wall surfaces. The applicant believes that the absence of sealing material, such as silicon, between adjacent walls reduces the risk of unwanted moulds and bacteria forming within the container.

The container 10 is preferably a wholly transparent container 10. In the illustrated embodiment of the invention, the container 10 is a glass brick dimensioned to engage similar glass bricks so as to form a display arrangement, such as a glass wall 19 (see FIG. 2). It will be appreciated that the container 10 alternatively may house and display fish and/or animal or insect matter and/or decorative or ornamental matter, such as multi-colored cobble stones, layers of different colored sands, glass beads, or the like.

The container 10 also includes at least one aperture extending through a wall of the container 10 for permitting access to contents 22 within the container 10. For this purpose the container 10 includes a tight-fitting plug 24, for example of cork, wood, rubber or glass, for sealing the aperture.

In those cases where the container is used as a housing for a terrarium, the container includes a first drainage soil layer 26 comprising a mixture of approximately 50% charcoal and 50% river sand into the container and leveling the drainage layer. The container also includes a second soil layer 28 comprising either a mixture of approximately 55% potting soil and 45% river sand for desert-type plants, or a mixture of approximately 80% potting soil and 20% peetmoss for forest-type plants into the container and leveling the soil layer. The terrarium may be primarily self-sustaining in that it does not require water, nutrients or other additions for a period of approximately 18 months.

FIG. 3 illustrates a container 10 encased within a wooden frame 30 for displaying the container on a desk, within a windowsill or the like.

In FIG. 4 the container 10 is located in an ornamental wall arrangement 32, including two platforms 34 for receiving candles thereon.

FIG. 5 is yet a further example of furniture incorporating the container 10 of the invention. In this embodiment, the container 10 is incorporated in a CD stand.

In preparing a terrarium according to the invention, the applicant first mixes 55% potting soil with 45% river sand (i.e. for desert-type plants), or 80% potting soil and 20% peetmoss (for forest-type plants). The soil mixture is tested so that it has a pH of between 5.6 and 6.5 and left to dry. The soil mixture is occasionally stirred during the drying process and treated with fungicide. While the mixture is drying, a drainage layer is prepared in the container by placing approximately 100 ml of a mixture of approximately 50% river sand and 50% charcoal in the bottom of the container. The drainage layer is leveled out with a dry paintbrush. Subsequently, approximately 500 ml of the soil mixture of potting soil and river sand, or potting soil and peetmoss, as the case may be, is placed in the container atop the drainage layer and leveled out with a dry paintbrush. The container with the drainage and soil mixtures are placed in a microwave oven and treated for between 1 and 2 minutes, and ideally for 1 minute and 40 seconds. The plug is placed in the aperture to seal the container and the container is allowed to cool down for at least 4 hours.

After cooling, a plant is planted in the soil layer. In the case of desert-type plants, the roots of the plants are neither trimmed nor washed before planting the plant. In the case of forest-type plants, however, the plant roots can be trimmed slightly, although washing of the same should be avoided. The plant roots are treated with 2.5 ml of fungicide, 5 ml of Nitrosol and 2 grams of Verikop before the plant is planted. After the plant is inserted into the container, the container is sealed with the plug.

It will be appreciated that many other embodiments of the invention may be possible without departing from the spirit or scope of the invention as defined in the claims.

1. An at least partially transparent container for use as an aquarium, herbarium, terrarium, vivarium or the like, the container comprising:
a building unit adapted for engaging complimentarily shaped containers so as to form a display arrangement;
a substantially continuous interior surface defining a chamber for housing fish and/or plants and/or animal or insect matter and/or decorative or ornamental matter;
radiused corner zones between interior surfaces of neighboring walls of the container; and
at least one salable aperture extending through a wall of the container for permitting access to the fish and/or plants and/or animal or insect matter and/or decorative or ornamental matter within the container.

2. The container according to claim 1, wherein the container is a substantially square or rectangular container comprising two substantially parallel sidewalls, two opposing substantially parallel end walls, and two parallel walls defining a floor and roof wall respectively of the container.

3. The container according to claim 1, wherein the container is a hollow, transparent glass brick dimensioned to engage similar glass bricks so as to form a display arrangement, such as a glass wall.

4. The container according to claim 1, wherein the container includes a tight-fitting plug for sealing the aperture, the plug being manufactured from any one of cork, wood, rubber, glass or the like.

5. An aquarium, herbarium, terrarium or vivarium comprising fish and/or plants and/or animal or insect matter and/or decorative or ornamental matter, the aquarium, herbarium, terrarium or vivarium being characterized therein that it is arranged within a hollow at least partially transparent container which is characterised therein that it includes a substantially continuous interior surface and radiused corner zones between interior surfaces of neighboring walls of the container; and at least one aperture extending through a wall of the container for permitting access to the animal and/or plant and/or insect matter and/or fish and/or decorative, ornamental or the like matter within the container.

6. A temporarily self-sustaining terrarium characterized therein that it is arranged within a hollow glass brick which includes a substantially continuous interior surface and radiused corner zones between interior surfaces of neighboring walls of the brick; and at least one aperture extending through a wall of the glass brick or permitting access to contents within the brick; the terrarium further being characterised therein that it includes a first drainage layer comprising a mixture of approximately 50% charcoal and 50% river sand.

7. The terrarium according to claim 6, wherein it includes a second layer for supporting plant material therein, the second layer comprising either a mixture of approximately 55% potting soil and 45% river sand for desert-type plants, or a mixture of approximately 80% potting soil and 20% peetmoss for forest-type plants.

8. A method of producing a temporarily self-sustaining terrarium that is arranged within an at least partially transparent container, the method comprising the steps of:
introducing a first drainage soil layer comprising a mixture of approximately 50% charcoal and 50% river sand into the container and leveling the drainage layer;
introducing a second soil layer comprising either a mixture of approximately 55% potting soil and 45% river sand for desert-type plants, or a mixture of approximately 80% potting soil and 20% peetmoss for forest-type plants into the container and leveling the soil layer;
sterilizing the soil mixtures by subjecting the container to microwave treatment so as to remove potentially unwanted bacteria; sealing the container and allowing the same to cool;
and introducing plant material into the container and sealing the container so as to create an ecosystem within which the plant material can grow in the absence of added oxygen or water.

9. A display arrangement comprising a series of containers, wherein each container includes fish and/or plants and/or animal or insect matter and/or decorative or ornamental matter, and wherein each container includes a substantially continuous interior surface and radiused corner zones between interior surfaces of neighboring walls of the container; and at least one aperture extending through a wall of the container for permitting access to contents within the container.

10. A wall structure comprising a series of containers, wherein each container includes fish and/or plants and/or animal or insect matter and/or decorative or ornamental matter, and wherein each container includes a substantially continuous interior surface and radiused corner zones between interior surfaces of neighboring walls of the container; and at least one aperture extending through a wall of the container for permitting access to contents within the container.

11. The wall structure according to claim 10, therein that wherein the wall structure is a glass wall comprising a series of hollow glass bricks wherein each brick includes fish and/or plant sand/or animal or insect matter and/or decorative or ornamental matter.

12. Furniture incorporating therein one or more of an aquarium, herbarium, terrarium or vivarium comprising fish and/or plants and/or animal or insect matter and/or decorative or ornamental matter wherein the aquarium, herbarium, terrarium or vivarium is arranged within a hollow glass brick.

13-18. (canceled)
